(19) United States
(12) Patent Application Publication
(10) Pub. No.: US 2012/0285943 A1
(43) Pub. Date: Nov. 15, 2012

(54) PORTABLE DEVICE FOR MELTING AND PROVIDING CHEESE AND OTHER MELTABLE FOODS, HEATED BY ELECTRIC POWER

(76) Inventor: Eduardo Vicente GUERRERO, Porto Alegre (BR)

(21) Appl. No.: 13/417,671

(22) Filed: Mar. 12, 2012

(30) Foreign Application Priority Data
May 13, 2011 (BR) PI 1102610-3

(51) Int. Cl. H05B 3/02

(52) U.S. Cl. 219/227

(57) ABSTRACT

Single hand portable and operated pistol shaped device for melting and providing cheese and other irregularly shaped meltable foods heated by electric power. Food reloading can be made holding the device in one hand completely assembled in its work position by nozzle in the frame. It has setable self controlled working temperature for different foods and a few moving parts that are reusable for new operations without dismantling. It has a cover to prevent accidents with hot parts. A single hand closing is needed for providing melted food and opening the hand the device gets ready automatically for new reloading and operation cycle. Main parts: piston, lever, frame, cover, heater and thermostat. Main operation features: fast, clean, safe and reliable. Low cost manufacture, simple and cheap to produce and sell.

### COMPARISON BETWEEN THE PRIOR ART FOUND IN USA AND THE PROPOSED INVENTION

1) U.S. Pat. No. 6,860,788 B2 Mar. 1, 2005

The device described in the mentioned patent, although it may have applications and utilities other than those described in the patent, it has three points below the model proposed in the new invention:
It has no perpendicular load opening to the axis of the cylinder, being necessary to remove the piston 114 for each new entry of chocolate no melted into the device. In the models without piston, it is necessary to remove a cover, or the pressure system to recharge, always made by the opposite tip of output of the meltable food. And it's necessary to use both hands and a table to do the operation, because the device must be partially disassembled.
Although several methods of food push were described, none of them is similar to that proposed, regards type of used lever, with the point of application of force between the rotation shaft of the lever and the part that pushes (in this case, the piston).
The device described, although it is described as portable, needs to be operated on a table, and using one hand to activate it. In the event of use it supported with hands, the both hands are required: one hand must support the device, and the other activating device of push. Unable to bear and activate the device with one hand only, by the descriptions and drawings provided in the patent.

### 2) US 2008/0041880 A1 Feb. 21, 2008

The device described in the mentioned patent, although it may have applications and utilities other than those described in the patent, it has at least three different and disadvantageous aspects to the model proposed in the new invention.
It has no perpendicular load opening (or lateral) to the axis of the cylinder, being necessary to disassemble the parts 64, 14, 50 and others for each new entry of chocolate no melted into the device. And it's necessary to use both hands and a table to do the operation, because the device must be partially disassembled, so you can reload it by tip. This makes loading slower and complicated.
The fact of having a threaded rod (part 20) within the cylinder, complicates the reloading operation, in addition to the hygiene of the device.
Food push system is motorized, being in this case required a system of motor, batteries, charger, switch, gears and screw, rather than a simple lever and piston system, simpler, cheap, reliable and maintenance free, as in the proposed invention. This fact will make also the facility to perform the correct internal hygiene.
Device is intended to provide food with precision, as in the case of decoration, but this fact hampers speed of reloading operation of motorized system, which reduces your ability to use in uses which require speed and simplicity of operation and larger quantities of meltable food, as the case of fast food or restaurants.
   3) U.S. Pat. No. 2,556,609 Jun. 12, 1951

The device described in the mentioned patent, although it may have applications and utilities other than those described in the patent, it has at least four different and disadvantageous aspects to the model proposed in the new invention:
It has no perpendicular load opening to the axis of the cylinder, being necessary to remove the piston backwards (parts 12 and 13) for each new entry of material no melted into the device, which should be made by the end part, and then enter it again in the cylinder. This complicates the reloading operation, becoming it slower
Although the method of meltable material push is similar, in that refers to the type of lever used, the model has more moving parts and springs, in addition to the disadvantage of needing several hand closures to provide a portion of melted material. As various hand closures are needed to evacuate all the material contained in the cylinder, the operation is slower.
It's not mentioned the presence of a thermostat, which in the case of foods that need heating to get fluids is necessary to avoid its cooking or burning.
It has no protection against accidental contacts in hot parts, particularly the piston when it is removed by end part to reload it.
   4) U.S. Pat. No. 6,460,736 B1 Oct. 8, 2002

The device described in the mentioned patent, although it may have applications and utilities other than those described in the patent, it has at least six different and disadvantageous aspects to the model proposed in the new invention:
It has a different push system, through trigger, that needs multiple activations to provide the entire food loaded in the device.
It requires more moving parts that impair the reliability of the device, such as springs, ball valve, and other parts.
It requires predetermined shapes of bar or recharge cartridges not being suitable for food of irregular way.
In the event of use with bar, noted that cannot be used a soft food such as cheese, with this device.
In the event of use of cartridge, recharge must be done by unmounting the same device and filling again with food, becoming more complicated and slow this operation. If the cartridge is disposable, the disadvantage is the increased cost of each cartridge.
It's not mentioned presence of a thermostat to maintain a stabilized temperature, which in the event of foods that need heating to get fluids it is necessary to avoid cooking or burning. Yes, it is mentioned a switch for various powers, but does not replace the function of a thermostat.
   5) U.S. Pat. No. 7,326,884 B1 Feb. 5, 2008

The device described in the mentioned patent, although it may have applications and utilities other than those described in the patent, has at least four different aspects that make it inappropriate for all proposed uses in new invention:
It's designed to provide food completely liquid, in the form of powdered or “spray”, not having application to materials more viscous as cheese or chocolate.
There isn't push system that can be used to dose viscous foods in the form of jet.
The device consists of two parts which are separable, a heater base and a powdered device with pump system, needing always of a table for the support, and of two hands for reloading operation, to partially disassemble the melted food depot.
Maintains the entire contents of food in the melted state, which is not expelled in each operation. This may entail risks of burns in the event of a fall and projection of hot material.

### 6) US 2003/0165793 A1 Sep. 4, 2003

The device described in the mentioned patent, although it may have applications and utilities other than those described in the patent, it has at least four different and disadvantageous aspects to the model proposed in the new invention:
It has a different push system for one type of lever that multiplies the strength and reduces the movement, as it is to provide small quantities of material very viscous, but it is not advantageous to larger quantities of soft elements, such as happens with food.
It requires a disposable cartridge for each supply of melted material.
Even if the cartridges are reusable, the reloading procedure is slower and more complex.
It requires predetermined shapes of reloading cartridges, not being suitable for irregularly shaped materials without cartridge.

### 7) US 2006/0021511 A1 Feb. 2, 2006

The device described in the mentioned patent, although it may have applications and utilities other than those described in the patent, has at least four different aspects that make it inappropriate for all proposed uses in new invention:
The device consists of two parts which are separable, a heater base and a device with pump system, needing always of a table for the support, and of two hands for reloading operation, to partially disassemble the melted food depot.
Maintains the entire contents of food on the melted state, which is not expelled in each operation. This may entail risks of burns in the event of a fall and projection of melted food.
It has a system of pump and valve, with multiple movable parts that hamper the hygiene, and can generate more frequent failures.
The pump system serves well for liquids, it is not appropriate for viscous foods, as the case of melted cheese.

### Description of the New Proposed Invention:

Portable Device for Melting and Providing Cheese and Other Meltable Foods, Heated by Electric Power

### TECHNICAL FIELD

The following detailed report for invention refers the development of a portable device for melting and providing cheese and other meltable foods, heated by electric power, where the machine is a pistol-type device with handle hold, operating lever, piston, electric heating elements and dosage tip; it is intended to provide melted cheese for various foods, such as hot dogs, pizza, Milanese, burgers, breads, cookies, and many other foods, whether or not of type fast food.

It is proposed an invention that allows the dosage of portions of cheese and other meltable foods, with application also for viscous foods, but not solid, which must be supplied hot, as sauces and other. The main purpose of the invention is its use in fast food, but not exclusive to it, and consistently and without major loss of time to reload it, whether in trades, or in domestic use. The proposed object has the following features in its entirety, it was not possible to find together in anteriorities studied. Although some existing devices have some or many of these features, none of them has all those listed below.
1. The device can be operated and held with one hand only, in the unloading of meltable food, without the need of table. This allows the device to be used on any food, dish or tray, regardless of the size or position of the same.
2. The device can be reloaded held in the same hand that operate it, putting food in their opening reloading without having to retreat or remove the piston from its operation normal position within the cylinder formed on the frame, or support at a table.
3. The device was designed to be reloaded without dismantling, either in total or partial manner.
4. In the operation of reloading all the parts are in their working position considered normal, the device is one thing, it is indivisible.
5. All constituent elements for each operation are reusable, none of them are disposable. The food is out of this assertion, because it is not part of the device.
6. It is secure, having its hot parties protected from accidental touch, and it expels most of hot food that has within it each time it is operated, minimizing the risk of burns.
7. It has an automatic temperature control system, to avoid boiling or burning of food that provides.
8. It has a system of simple moving parts, with few parts, that require little maintenance and minimizes the possibility of failures.
9. The unloading of meltable food can be made in a single movement, one hand closing, simple and fast, as befits its commercial use.
10. It is easily cleaned.
11. It can be reloaded with raw food without predetermined shapes for reloading. This means that it is appropriate to reload with irregularly shaped foods, common on meltable or soft foods.

### PRIOR ART

Machines for melting cheese in industrial processes are known from the art, but they consist of large equipment in order to operate on a continuous basis.

Cheese is manually melted by heating within a container. The heat can be produced by gas, spirit lamp, electric heating elements in an electric pan, microwave and so on.

It was not find any equipment for melting food by using electric heating elements that is similar to the portable device proposed.

### DISCUSSION

Therefore, due to considerations relevant to the prior art discussed above it is among the aims of the this invention, the development of a device for melting cheese and other meltable foods primarily intended to soft cheese, with a low melting point, Mozzarella, Provolone or Cheddar type; but with a more powerful heater it can be used for other types of cheese in addition to other foods like chocolate or butter and any meltable or soft foods that need to be heated. The handle hold has a pressure lever for the user to adjust the dosage of food according to what he wants to. The supply of cheese (or other product) and its amount can be adjusted also by changing the dosage tip, if there is another one, being this planned in more complex models. The device has an adjustable thermostat for various temperatures that can work for thermocouple, electronics or electromechanical systems.

The materials used in its development can be stainless metals such as stainless steel and aluminum, metals or alloys enameled or covered with Teflon, or heat-resistant polymers, ceramic material may be used in the parts subjected to intense heat. Regular copper electric conductor for power supply. The electric heating element may be metallic or ceramic and it is in a part at the end of the cylinder, before the dosage tip, covered in order to prevent burns in its operation. The device maintain the cheese within the cylinder without melting it; being melted the cheese passing through heater with hot electric heating element, insofar as it is pushed by the piston, activated by the pressure on the lever. This detail allows the device to be supplied without the need to be disassembled, by only retreating the piston and the lever and putting another piece of cheese (or any other food) inside the cylinder by lateral nozzle with lid. The lid can rotate in the frame, without taking it out, by means of a small flexible hinge. This detail is not shown on the drawings. It can also have a magnetic pressure clasp or to keep it in the closed position, without open during operation of the piston.

When not used, the device can be placed on a support or hook, not shown in the figures, that holds it in a vertical manner in order to avoid dropping of the cheese that may be on the nozzle or tip. All parts, frame, electric heating element, cylinder, piston and lever can be disassembled by parts to allow proper hygiene of the device periodically. Nevertheless, in daily use the device can have cheese inside it, if properly refrigerated.

### LIST OF FIGURES

The characterization of this document as a patent of invention is made by means of drawings representing the portable device for melting and providing cheese and other meltable foods, so that the machine can be fully reproduced by proper technique, allowing full characterization of the functionality of the object to be patented.

From the figures created that express the best or preferred way of performing the product hereby idealized, it is based the descriptive part of the report with a detailed and consecutive numbering, where there are explained aspects that may be implied by the representation adopted, in order to determine clearly the protection hereby intended.

These figures are given for illustrative purposes and may vary since they do not differ from the scope initially pleaded.

Therefore, there are:

FIG. 1: illustrates the side view (A), frontal view (B) and upper view (C) of the proposed device;

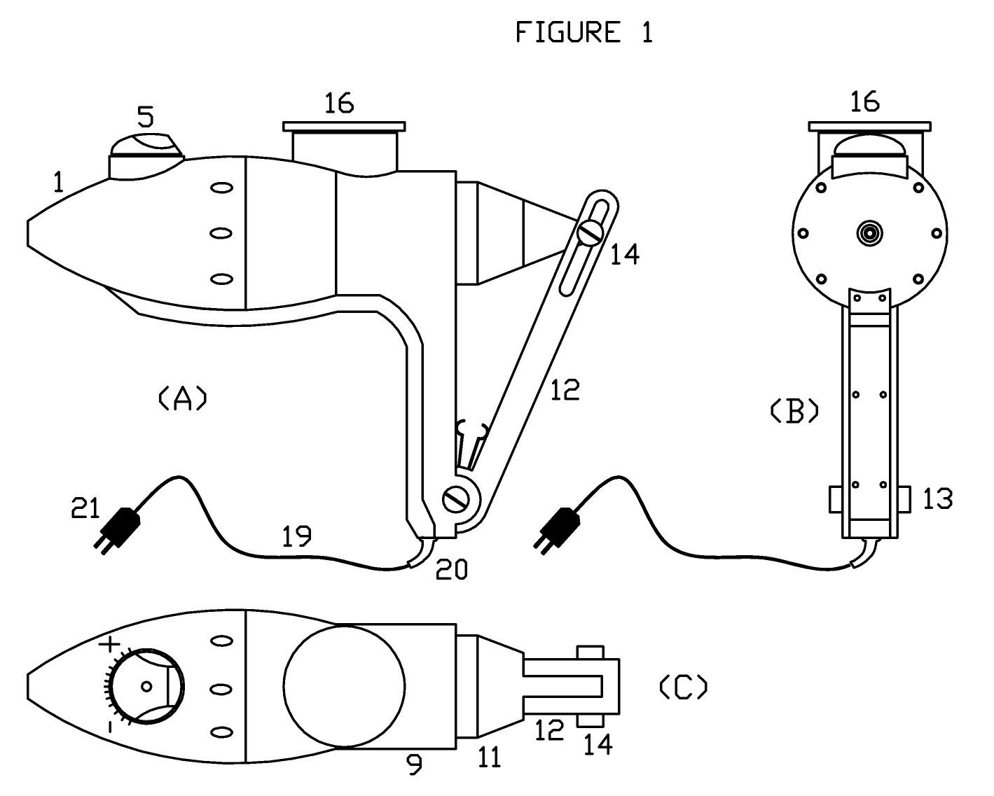

FIG. 2: shows a longitudinal cut of the device and;

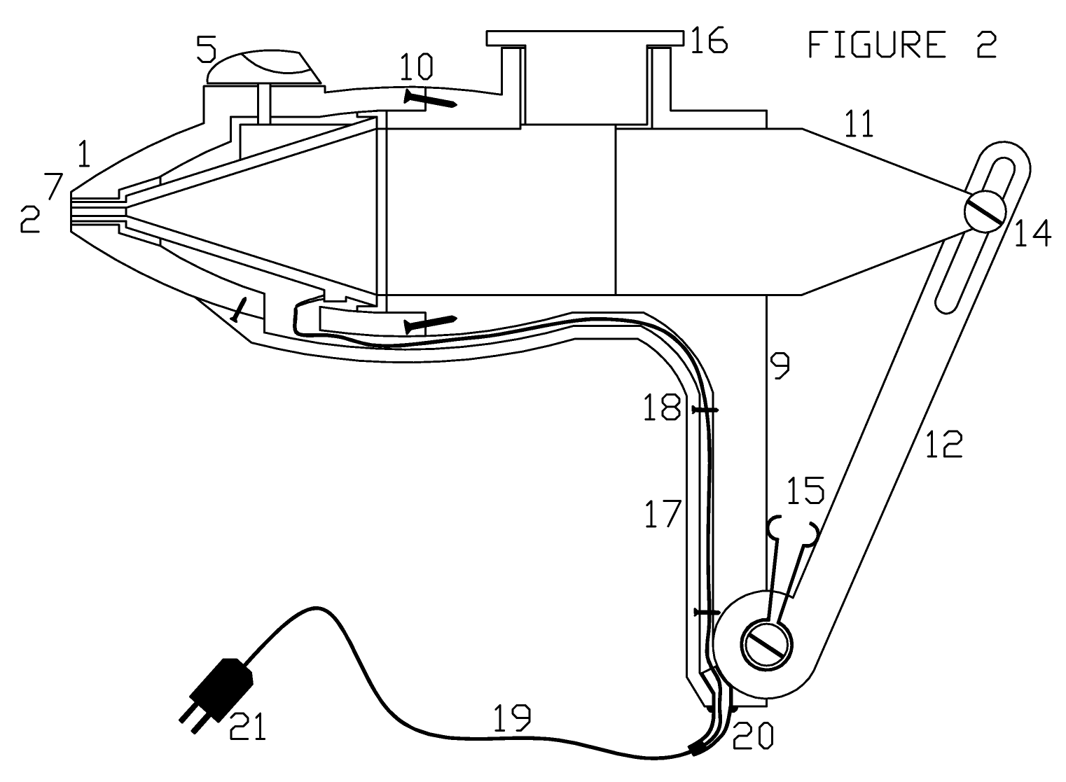

FIG. 3: shows the device disassembled.

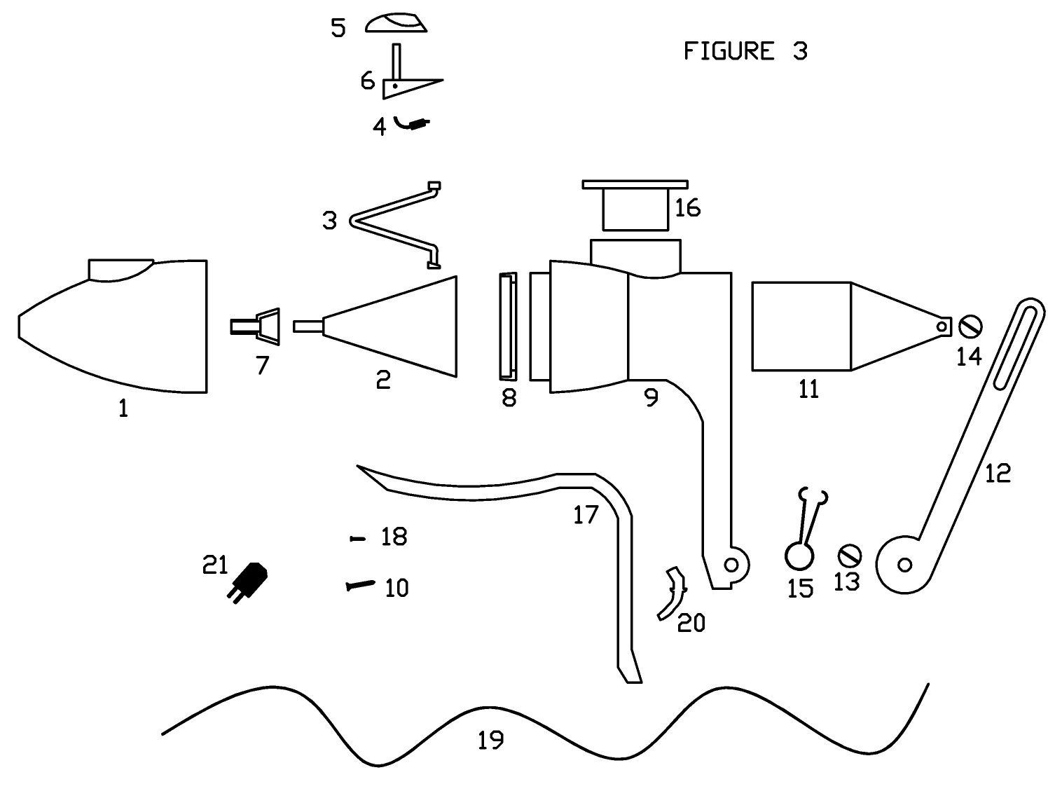

### DESCRIPTION

The device as a whole has a pistol shape, comprised of a main body and a handle hold to take and operate by hand. The melted food is expelled by the tip of the device, which allows it to be applied directly onto the surface you want to. The power cord from the mains comes out by the lowest part of the handle hold.

The device comprises a cover (1) which protects it against burns and covers the part where the heater (2) is, with the heater being provided in the form of a funnel, where the melted food goes through it being available at the tip, with a front seal (7) able to maintain the heater (2) separate from the cover (1); in the heater (2) there are the electrical heating elements (3), containing a fuse (4) that is connected to the thermostat (6) associated with the temperature control button (5).

Between the cover (1) and the frame (9) there is the back seal (8) used to keep the heater separate from the cover and the frame, to reduce their transmission of heat, preventing the entry of melted food into the device in the thermostat zone. The frame (9) has on its top the lid (16), fixed through the hinge (not shown in the drawing) covering the insertion nozzle to the food to be melted, a piston (11) composed of a cylindrical part and a conical one, used to push the new food no melted into the heating zone; in the end of the conical piston (11) there is a pin (14) connected to a lever (12) that contains an oblong hole where the pin passes through (14), and the piston can be forced using this lever (11), pushing the food to the melting zone; the lever referred to (12) is attached by its lower end to the bottom of the frame, a place where comes out the cable of the device, by a shaft (13) that allows turning the lever on the frame, keeping the two parts together, but with relative motion between them, and there is a spring (15) between the lever (12) and the frame (9). The shape, proportions and proposed length of the piston (11) may vary, to decrease or eliminate the amount of melted cheese on the cylinder, each operation, with that provided down in the invention.

The power cord (19) arises from the bottom of the frame with the flexible shield (20) and a grounded electrical outlet (21). Connected to the frame (9) next to the handle hold of the device there is a guide (17) of the electrical cable (19), protecting the electrical cable (19) from its connection to the electric heating elements (3) to the flexible shield (20).

The device is connected to the mains through the grounded type outlet (21), then the three-wire power cord (19) will provide power to the internal electric circuit of the device consisted of two electric heating elements (3), a thermostat (6) and a fuse (4), all connected electrically in series. The flexible shield (20) serves only to protect the three-wire cable from damages against the hard parts of the frame (9), and the cable guide, (17) to protect the internal connections from accidental pulling. It will be fixed by pressure between (9) and (17). The cable guide (17) keeps the three-wire cable attached and covered so that it is protected, following the internal contour of the device and it will be bolted on its frame. The number and shape of the resistors can be different from that proposed, in accordance with the convenience of manufacturing.

### Operation

A working temperature is selected by using the button (5), which serves to move the internal parts of the thermostat in order to keep the working temperature close to the desired by the user. Then the heat produced by the electric heating elements (3), solidly attached to the heater (2) by welding or other industrial method, will warm this until it reaches the selected temperature, turning off the thermostat which will be mounted directly over the heater. If the heater cools down, the thermostat will automatically turn on the electric heating elements in order to reach again the selected temperature. If there is a failure in the thermostat, the fuse (4) will interrupt the power supply in order to prevent overheating or accidents, since it is also mounted on the heater and has the same temperature. When the lid is removed (16), which is mounted with hinge and a small clearance on the top hole of the frame, a piece of meltable food is inserted (cheese, chocolate, butter, or any other) inside the internal cylinder formed inside the frame by the hole left open when removing the lid.

Then, the lid is placed again, and closing with the hand supporting the device, the pressure is made on the lever (12), which rotates on the shaft (13) mounted in the frame (9), and pushes the piston (11) by the movement of the pin (14) mounted on it. The piston (11) will push the food inside the frame (9) and will make it pass through the heater in a funnel-shaped way. In contact with it, the food melts and is delivered melted in the tip of the device to be placed where desired. The front seal (7) and the back seal (8) serve to prevent the entry of food in the limited area between the cover (1), heater (2) and electric heating elements (3), as well as to avoid excessive heating of the cover. The cover is mounted and fixed on the frame by using eight type-A screws (10). However, the cable guide is fixed by six type-B screws in the cover and the frame.

When the food has already been melted and used, the spring (15) placed on the shaft (13), and making pressure between the lever (9) and the frame (12), pushes back the lever and also the piston, leaving the device ready for another cycle of use, opening the lid and introducing new food into the device.

The frame, piston and lever can be disassembled by parts to allow proper internal hygiene of the device periodically. Nevertheless, in daily use the device can have cheese inside it, if properly refrigerated.

Note that the handle hold is composed of either the lower protrusion of the frame, the cable guide and the lever (movable part), being composed of several parts. The meaning of the words “handle hold” here refers to the location where the device is held and operated by the pressure of the user's hand.

The following change possibilities are provided in the invention:
Materials: polymers, resins, thermoplastics, thermosets, metals, tempered glass or non-tempered glass, metal alloys, whether painted, covered with other material or enamel, or combinations of the previous ones.
On/off switch—it may or may not have it.
Lights or LED temperature indicators or On/Off—it may or may not have it.
Parts assembly: it may be mounted by threads in the body, screwed, coupled by pressure, or clamps.
The external shape of the Frame may be extended up to end part of the instrument (variation not shown in the drawing) so that the piston and the tip of the lever are fully covered, to improve the appearance of the device, but keeping the same principles of operation already described.
Ergonomics: the proportions, shape, and handle hold lever angle and frame, may be changed to obtain a greater comfort in the operator's hand, being those provided for this invention.
Shape: the melter's shape can be a cylinder, cone, pyramidal, rectangle, square or oval.
Section of cylinder: round, square, rectangular, oval.
Electric heating element: metal wire, alloy, coal, ceramic or semi-conductor (may be one or more).
Thermostat: systems similar to those used in irons, bi-metals systems, it can use electronic or not to vary the power supplied. Rotating or sliding button: Button to be pressed or triggered by touch. Depending on usage can be a fixed temperature thermostat.
It may have or a not interchangeable tips, depending on the service is intended.
It may have any size provided that could be possible to be supported and operated by a human hand.
The device power may vary depending on size and flow or melted food flow intended to be provided; it is a manufacturer's decision and a buyer's choice. The only limitation in power may occur depending on the materials used to manufacture it that must withstand the temperature and maintain the physical integrity of the user, provided that it is used with common sense.

1. PORTABLE DEVICE FOR MELTING AND PROVIDING CHEESE AND OTHER MELTABLE FOODS, HEATED BY ELECTRIC POWER, characterized by the fact that it is a pistol-type device with handle hold, equipped with an operating lever (12), which moves a piston (11), which pushes food to be heated to the heater area (2) and electric heating elements (3), and the melted food referred to can be provided at the tip of the cover (1), which provides that in the amount and flow rate proportional to the lever pressure (12).

2. PORTABLE DEVICE FOR MELTING AND PROVIDING CHEESE AND OTHER MELTABLE FOODS, HEATED BY ELECTRIC POWER, according to claim 1 and characterized by the fact it has a cover (1) which protects against burns and covers the part where the heater (2) is, and this heater is provided in the form of a funnel, where the melted food passes and is made available at the tip, and it has a front seal (7) able to keep the heater (2) separate from the cover (1); in the heater (2) there are two electric heating elements (3), a fuse (4) that is connected to the thermostat (6) associated with the temperature control button (5).

3. PORTABLE DEVICE FOR MELTING AND PROVIDING CHEESE AND OTHER MELTABLE FOODS, HEATED BY ELECTRIC POWER, according to claim 1 and characterized by the fact that it has between the cover (1) and the frame (9) a back seal (8) to maintain the heater separated from the cover and the frame, and to prevent the entry of melted food into the device in the thermostat area.

4. PORTABLE DEVICE FOR MELTING AND PROVIDING CHEESE AND OTHER MELTABLE FOODS, HEATED BY ELECTRIC POWER, according to claim 3 and characterized by the fact that the frame (9) holds in the top the lid (16) that covers the insertion nozzle for the food to be melted, a piston (11) composed of a cylindrical part and a conical one, used to push the new food no melted toward the heating area, and that in conical part of the piston (11) is placed in a pin (14) connected to a lever (12) containing an oblong hole where the pin is (14), by this lever one can force the piston (11) pushing the food to the melting area; and the lever (12) is attached for its lower part to the lower end of the frame (9) through a shaft (13) that allows the rotation of the lever in the frame, keeping the two parts united, but with relative motion between them, and also has a spring (15) between the lever (12) and the frame (9).

5. PORTABLE DEVICE FOR MELTING AND PROVIDING CHEESE AND OTHER MELTABLE FOODS, HEATED BY ELECTRIC POWER, according to claim 4 and characterized by the fact that the lower part of the frame (9) there is a power cord (19) with the flexible shield (20) and grounded type outlet (21).

6. PORTABLE DEVICE FOR MELTING AND PROVIDING CHEESE AND OTHER MELTABLE FOODS, HEATED BY ELECTRIC POWER, according to claim 1 it is characterized by the fact that connected to the frame (9) next to the handle hold of the device, there is a guide (17) of the electrical cable (19), protecting the electrical cable (19) from its connection to the electric heating elements (3) to the flexible shield (20).
